(19) United States
(12) Patent Application Publication
(10) Pub. No.: US 2020/0196618 A1
(43) Pub. Date: Jun. 25, 2020

(54) CRUNCHY BAKED SNACKS

(71) Applicant: Pepperidge Farm, Incorporated, Norwalk, CT (US)

(72) Inventors: Guisselle Cedillo Sebastian, Stamford, CT (US); Karthick Athmaram, Fairfield, CT (US); Nurhan Pinar Tutuncu, Stamford, CT (US); Craig Slavtcheff, Washington Crossing, PA (US)

(21) Appl. No.: 16/720,820

(22) Filed: Dec. 19, 2019

Related U.S. Application Data
(60) Provisional application No. 62/782,812, filed on Dec. 20, 2018.

(51) Int. Cl. A21D 13/48; A21D 13/047

(52) U.S. Cl. CPC A21D 13/48; A21D 13/047

(57) ABSTRACT

Embodiments herein include crunchy baked snacks and methods of making the same. In an embodiment, a baked snack is included. The baked snack can include a three-dimensional structure comprising a top layer and a bottom layer and defining a hollow cavity between the top layer and the bottom layer. In an embodiment, the three-dimensional structure is formed from a dough composition a corn flour, a tapioca flour, and a starch. The three-dimensional structure can include a first end segment, a second end segment, and a middle segment disposed between the first end segment and the second end segment. The average height of the hollow cavity can be less in the second end segment than in the first end segment. The average height of the hollow cavity can be less in the first end segment than in the middle segment. Other embodiments are also included herein.

This application claims the benefit of U.S. Provisional Application No. 62/782,812, filed Dec. 20, 2018, the content of which is herein incorporated by reference in its entirety.

### FIELD

Embodiments herein relate to baked snacks and methods of making the same. More specifically, embodiments herein relate to crunchy baked snacks and methods of making the same.

### BACKGROUND

Snack foods are a significant segment of the overall food market. The global sweet and savory snack segment is estimated to be over 144 billion dollars in 2018. Sweet and savory snacks include crisps and chips, extruded snacks, popcorn, nut-based snacks, pretzels, fruit snacks, and the like.

Various sensory properties are important to consumers depending on the specific type of snack food. With respect to the crisps, chips and pretzels, in particular, many consumers desire a crunchy eating experience. In many cases, such snacks have been fried, giving them a crispy and sometimes crunchy texture. Unfortunately, fried snacks generally include a very high fat content. Therefore, some consumers prefer baked snacks in part because of lower fat content. However, achieving certain desirable consumer sensory properties such as crunchiness in a baked snack remains challenging.

### SUMMARY

Embodiments herein include crunchy baked snacks and methods of making the same. In an embodiment, a baked snack is included. The baked snack can include a three-dimensional structure comprising a top layer and a bottom layer and defining a hollow cavity between the top layer and the bottom layer. In an embodiment, the three-dimensional structure is formed from a dough composition a corn flour, a tapioca flour, and a starch. The three-dimensional structure can include a first end segment, a second end segment, and a middle segment disposed between the first end segment and the second end segment. The average height (e.g., mean height) of the hollow cavity can be less in the second end segment than in the first end segment. The average height (e.g., mean height) of the hollow cavity can be less in the first end segment than in the middle segment.

In an embodiment, a baked snack is included. The baked snack can include a three-dimensional structure defining a hollow cavity. The three-dimensional structure can include a top layer and a bottom layer disposed opposite the top layer. The top layer can define a first arch. The bottom layer can define a second arch. The first arch and the second arch can be inverted with respect to one another. The bottom layer defining the second arch can have an average thickness that is greater than the top layer defining the first arch.

In an embodiment, a method of making a baked snack is included. The method can include forming a dough composition. The dough composition can include a corn flour, 5 to 30 percent of a tapioca flour relative to the weight of the corn flour, 5 to 20 percent of a starch relative to the weight of the corn flour, 25 to 40 weight percent water, 3 to 10 weight percent vegetable oil, and a leavening agent. The method can include sheeting the dough to a thickness of 1.5 to 3 millimeters, cutting the sheeted dough to form individual pieces, and baking the individual pieces to reduce the moisture content to less than about 3.5 weight percent.

In an embodiment, a baked snack is included. The baked snack can include a three-dimensional structure comprising a top layer and a bottom layer. The three-dimensional structure can define a hollow cavity between the top layer and the bottom layer. The three-dimensional structure can be formed from a dough composition including a first flour, a second flour different than the first flour, and a starch. The three-dimensional structure can include a first end segment, a second end segment, and a middle segment disposed between the first end segment and the second end segment. The average height of the hollow cavity can be less in the second end segment than in the first end segment. The average height of the hollow cavity can be less in the first end segment than in the middle segment.

In an embodiment, a baked snack is included. The baked snack can include a three-dimensional structure including a top layer and a bottom layer and can define a hollow cavity between the top layer and the bottom layer. The three-dimensional structure can be formed from a dough composition including potato flakes, potato flour, and a starch. The three-dimensional structure comprising a first end segment, a second end segment, and a middle segment disposed between the first end segment and the second end segment. The average height of the hollow cavity can be less in the second end segment than in the first end segment. The average height of the hollow cavity can be less in the first end segment than in the middle segment.

This summary is an overview of some of the teachings of the present application and is not intended to be an exclusive or exhaustive treatment of the present subject matter. Further details are found in the detailed description and appended claims. Other aspects will be apparent to persons skilled in the art upon reading and understanding the following detailed description and viewing the drawings that form a part thereof, each of which is not to be taken in a limiting sense. The scope herein is defined by the appended claims and their legal equivalents.

### BRIEF DESCRIPTION OF THE FIGURES

Aspects may be more completely understood in connection with the following figures (FIGS.), in which:

FIG. 1 is a schematic plan view of a baked snack in accordance with various embodiments herein.

FIG. 2 is a schematic cross-sectional view of a middle segment of a baked snack in accordance with various embodiments herein as taken along line 2-2′.

FIG. 3 is a schematic cross-sectional view of a first end segment of a baked snack in accordance with various embodiments herein as taken along line 3-3′.

FIG. 4 is a schematic cross-sectional view of a second end segment of a baked snack in accordance with various embodiments herein as taken along line 4-4′.

FIG. 5 is a schematic plan view of a baked snack in accordance with various embodiments herein.

FIG. 6 is a schematic plan view of a baked snack in accordance with various embodiments herein.

FIG. 7 is a schematic plan view of a baked snack in accordance with various embodiments herein.

FIG. 8 is a three-dimensional scan and cross-section of a baked snack in accordance with various embodiments herein.

FIG. 9 is a three-dimensional scan and cross-section of a baked snack in accordance with various embodiments herein.

FIG. 10 is a three-dimensional scan and cross-section of a baked snack in accordance with various embodiments herein.

FIG. 11 is a force deformation plot comparing comparative examples of snacks with baked snacks in accordance with various embodiments herein.

FIG. 12 is a frequency spectrum of a baked snack in accordance with various embodiments herein.

FIG. 13 is a cumulative frequency spectrum of a baked snack in accordance with various embodiments herein.

FIG. 14 is a frequency spectrum of a comparative example of a snack.

FIG. 15 is a cumulative frequency spectrum of a comparative example of a snack.

FIG. 16 is a frequency spectrum of a comparative example of a snack.

FIG. 17 is a cumulative frequency spectrum of a comparative example of a snack.

FIG. 18 is a frequency spectrum of a comparative example of a snack.

FIG. 19 is a cumulative frequency spectrum of a comparative example of a snack.

FIG. 20 is a spider plot of sensory attributes showing the difference between comparative snacks and baked snacks in accordance with various embodiments herein.

FIG. 21 is a spider plot of sensory attributes showing the difference between comparative snacks and baked snacks in accordance with various embodiments herein.

FIG. 22 is a three-dimensional scan and cross-section of a comparative baked snack.

FIG. 23 is a three-dimensional scan and cross-section of a comparative baked snack.

FIG. 24 is a three-dimensional scan and cross-section of a comparative baked snack.

While embodiments are susceptible to various modifications and alternative forms, specifics thereof have been shown by way of example and drawings, and will be described in detail. It should be understood, however, that the scope herein is not limited to the particular aspects described. On the contrary, the intention is to cover modifications, equivalents, and alternatives falling within the spirit and scope herein.

### DETAILED DESCRIPTION

Many consumers desire a crunchy sensory experience with various types of snack foods. Many fried snacks have a crispy, crunchy texture. However, fried snacks generally include a very high fat content. In addition, many fried snacks retain a substantial amount of oil on their surface making them messy to eat.

Embodiments herein include baked snacks with a much lower fat content than most fried snacks, but with a remarkable degree of crunchiness. The baked snacks herein are formed from a corn flour-based dough (vs. wheat flour-based doughs) and have a substantial hollow cavity.

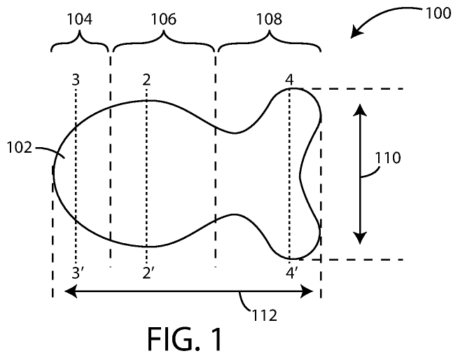

Referring now to FIG. 1, a schematic plan view is shown of a baked snack 100 in accordance with various embodiments herein. The baked snack 100 has a length 112 and a width 110. The length 112 can be from about 1 cm to about 7 cm. The length 112 can be about 1.5, 2, 2.5, 3, 3.5, 4, 4.5, 5, 5.5, 6, or 6.5 cm, or can fall within a range between any of the foregoing. The width 110 can be from about 0.75 cm to about 5 cm. The width 110 can be about 1, 1.5, 2, 2.5, 3, 3.5, 4, or 4.5 cm, or can fall within a range between any of the foregoing. In various embodiments, the length 112 is greater than the width 110. In various embodiments, the length 112 is at least 1.1, 1.2, 1.3, 1.4, 1.5, 1.8, 2, 2.5, 3, 3.5, 4, 4.5, or 5 times the width 110, or an amount falling within a range between any of the foregoing.

In various embodiments, the baked snack 100 includes a three-dimensional body structure 102. The three-dimensional body structure 102 can be produced by baking a dough composition. After baking, the three-dimensional body structure 102 can be porous. Details of exemplary dough compositions are described in greater detail below.

The three-dimensional structure 102 can include a first end segment 104, a second end segment 108, and a middle segment 106 disposed between the first end segment 104 and the second end segment 108. The first end segment 104 can be about 5% to about 40% of the overall length 112 of the baked snack 100. The second end segment 108 can be longer than the first end segment 104. In various embodiments, the second end segment 108 can be about 10% to about 50% of the overall length of the baked snack 100. The middle segment 106 can be the remainder between the first end segment 104 and the second end segment 108. The middle segment 106 can be about 10% to about 50% of the overall length of the baked snack 100.

In various embodiments, the baked snack 100 is asymmetric along its length 112. As such, the segments can vary from one another and, in particular, the end segments (first end segment 104 and second end segment 108) can be different from one another and not simple mirror images of one another. Further details regarding these segments are described in greater detail below. However, in various embodiments, the average height of the hollow cavity is less in the second end segment than in the first end segment. Further, the average height of the hollow cavity can be less in the second end segment than in the middle segment. As used herein, the term “average” shall refer to the mathematical mean unless the context dictates otherwise.

The baked snacks herein can be hollow (e.g., can define a hollow cavity). In various embodiments, the hollow cavity can be surrounded on all sides by the three-dimensional body structure (e.g., not open on a side). While not intending to be bound by theory, it is believed that the hollow cavity, and the collapse thereof during the chewing process, can contribute to the crunchy sensory properties of the baked snack. In various embodiments herein, the hollow cavity differs in height across the body/shape of the baked snack. The distance between the top and bottom layer changes as you move from one lengthwise end to the other. The difference in distance is believed to impact crunchiness and the force to compress the product. In addition, the wall thickness of the three-dimensional body structure 102 varies across the product and, in specific, varies from top to bottom and from one lengthwise end to the other with thicker cell walls closer to the end sections which are believed to impact the force required to compress the product.

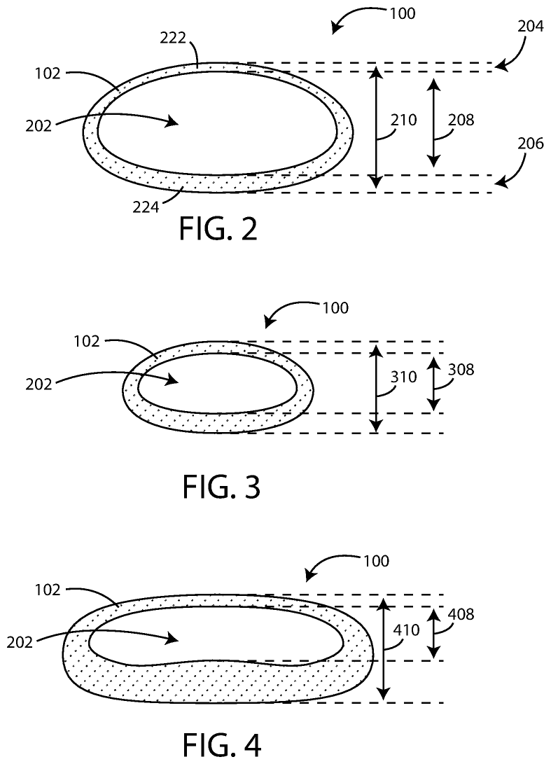

Referring now to FIG. 2, a schematic cross-sectional view is shown of a baked snack 100 as taken along line 2-2′ of FIG. 1, in accordance with various embodiments herein. As such, the cross-section of FIG. 2 represents a cross-section of the middle segment 106. The three-dimensional body structure 102 can include a top layer 222 and a bottom layer 224 and can define a hollow cavity 202 between the top layer 222 and the bottom layer 224. The hollow cavity 202 has a cross-sectional diameter or height 208 and the three-dimensional structure 102 itself has a cross-sectional diameter or height 210. The middle segment 106 can have a cross-sectional ratio of the diameter (or height) of the hollow cavity to the outer diameter (or height) of the three-dimensional structure of about 0.5, 0.6, 0.7, 0.75, 0.8, 0.85, 0.9, 0.95 or 0.98, or an amount falling within a range between any of the foregoing.

In the specific example shown in FIG. 2, the cross-sectional area of the hollow cavity 202 is approximately 71% of the cross-sectional area of the entire cross-section of the baked snack 100. However, it will be appreciated that this is merely one specific example. In various embodiments, the cross-sectional area of the hollow cavity 202 in the area of the middle segment 106 with respect to the cross-sectional area of the entire cross-section of the baked snack 100 can be about 40, 45, 50, 55, 60, 65, 70, 75, 80, or 85 percent, or can fall within a range between any of the foregoing. The ratio of the average area of the hollow cavity 202 to the average area of the entire cross-section of the baked snack 100 can be higher in the middle segment 106 than in the other two segments.

In various embodiments, the top layer 222 can define a first arch. The bottom layer 224 can define a second arch. The first arch and the second arch can be inverted with respect to one another. The bottom layer 224 defining the second arch can have an average thickness 206 that is greater than the average thickness 204 of the top layer defining the first arch. By way of example, the bottom layer defining the second arch can have an average thickness that is at least 10, 20, 30, 40, 50, 60, 75, 100, 150, 200, or 300 percent greater than the top layer defining the first arch, or an amount greater falling within a range between any of the foregoing. In various embodiments, the force required to compress the second arch can be at least 10, 20, 30, 40, 50, 60, 75, 100, 150, 200, or 300 percent than the force required to collapse the first arch, or an amount falling within a range between any of the foregoing.

Referring now to FIG. 3, a schematic cross-sectional view is shown of a first end segment 104 of a baked snack in accordance with various embodiments herein as taken along line 3-3′ of FIG. 1. The hollow cavity 202 in the area of the first end segment 104 has a cross-sectional diameter or height 308 and the three-dimensional structure 102 itself has a cross-sectional diameter or height 310. The first end segment can have an average cross-sectional ratio of the diameter of the hollow cavity to the outer diameter of the three-dimensional structure that is less than the middle segment. The first end segment 104 can have a cross-sectional ratio of the diameter (or height) of the hollow cavity to the outer diameter (or height) of the three-dimensional structure of about 0, 0.1, 0.2, 0.3, 0.4, 0.5, 0.6, 0.7, 0.75, 0.8, 0.85, or 0.9, or an amount falling within a range between any of the foregoing.

In the specific example shown in FIG. 3, the cross-sectional area of the hollow cavity 202 is approximately 55% of the cross-sectional area of the entire cross-section of the baked snack 100. However, it will be appreciated that this is merely one specific example. In various embodiments, the cross-sectional area of the hollow cavity 202 in the area of the first end segment 104 with respect to the cross-sectional area of the entire cross-section of the baked snack 100 can be about 30, 35, 40, 45, 50, 55, 60, 65, 70, 75, 80, or 85 percent, or can fall within a range between any of the foregoing.

Referring now to FIG. 4, a schematic cross-sectional view is shown of a second end segment of a baked snack in accordance with various embodiments herein as taken along line 4-4′ of FIG. 1. The hollow cavity 202 in the area of the second end segment 108 has a cross-sectional diameter or height 408 and the three-dimensional structure 102 itself has a cross-sectional diameter or height 410. The second end segment 108 has an average cross-sectional ratio of the diameter of the hollow cavity 202 to the outer diameter of the three-dimensional structure that is less than the first end segment 104. The second end segment 108 can have a cross-sectional ratio of the diameter (or height) of the hollow cavity 202 to the outer diameter (or height) of the three-dimensional structure of about 0, 0.1, 0.2, 0.3, 0.4, 0.5, 0.6, 0.7, 0.75, or 0.8, or an amount falling within a range between any of the foregoing.

In the specific example shown in FIG. 4, the cross-sectional area of the hollow cavity 202 is approximately 43% of the cross-sectional area of the entire cross-section of the baked snack 100. However, it will be appreciated that this is merely one specific example. In various embodiments, the cross-sectional area of the hollow cavity 202 in the area of the second end segment 108 with respect to the cross-sectional area of the entire cross-section of the baked snack 100 can be about 10, 15, 20, 25, 30, 35, 40, 45, 50, 55, 60, 65, 70, or 75 percent, or can fall within a range between any of the foregoing.

Thus, in various embodiments, the combined average thickness of the top layer and bottom layer can be greater in the second end segment 108 than in the first end segment 104. The combined average thickness of the top layer and bottom layer can be greater in the first end segment 104 than in the middle segment 106.

The crunchy sensory properties of baked snacks in accordance with embodiments herein can substantially exceed those of known baked snacks. As shown in the examples below, the compression of the hollow cavities of baked snacks herein result in sound waves with a largest peak at an acoustic frequency of less than 2.5, 2.4, 2.3, 2.2, 2.1, 2, 1.9, 1.8, 1.7, 1.6, or 1.5 kHz. In some embodiments, the baked snacks herein can include at least 10, 11, 12, 13, 14, 15, 16, 17, 18, 19, 20, or 25 percent or more, or an amount falling within a range between any of the foregoing, of cumulative acoustic frequencies below 1.7 kHz.

In various embodiments, the compression of the hollow cavities of baked snacks herein result in a linear distance of at least about 30,000, 40,000, 50,000, 60,000, 70,000, 80,000, 90,000, or 100,000 g/s, or an amount falling within a range between any of the foregoing.

In various embodiments, the compression of the hollow cavities of baked snacks herein result in an average drop-off of greater than 200, 300, 4000, 500, 600, 700, 800, 900, or 1000 g, or an amount falling within a range between any of the foregoing.

In various embodiments, the compression of the hollow cavities of baked snacks herein result in an average number of compression peaks greater than 30, 40, 50, 60, 70, 80, 90, 100, 110, or 120, or an amount falling within a range between any of the foregoing.

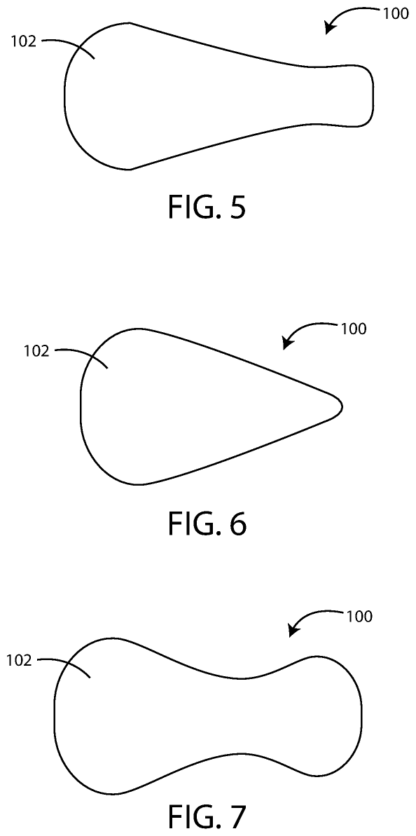

It will be appreciated that baked snacks herein can take on various shapes (such as when viewed as a plan view). FIGS. 5-7 are schematic plan views of baked snacks 100 in accordance with various embodiments herein having plan view profiles different than the baked snack of FIG. 1.

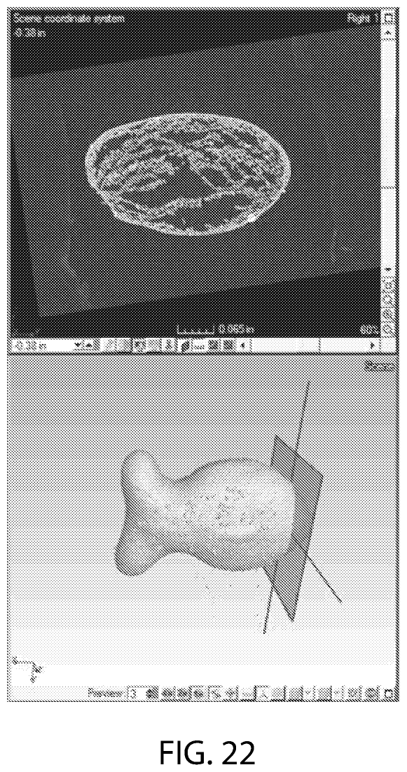

While the shape shown in FIG. 1 has an exterior profile in plan view that resembles GOLDFISH® brand baked snacks as sold by Pepperidge Farm, Norwalk, Conn., preexisting GOLDFISH® brand baked snacks do not have hollow cavities like those described herein. In specific, preexisting GOLDFISH® brand baked snacks have much smaller internal cavities, if any at all. Cross-sectional image of an exemplary preexisting GOLDFISH® brand baked snack is attached hereto as FIGS. 22-24 and are described in Example 6. Also, preexisting GOLDFISH® brand baked snacks are formed from traditional wheat flour-based doughs, not corn flour-based doughs as described herein. Further, preexisting GOLDFISH® brand baked snacks do not have crunchy sensory properties as described herein.

### Dough Compositions

Baked snacks herein can be formed from a dough composition. In various embodiments, the dough can include a first flour, a second flour different than the first flour, and a starch. In various embodiments, the first flour can be selected from the group consisting of corn flour, potato flour and rice flour. In some embodiments the second flour selected from the group consisting of tapioca flour, potato flour and rice flour.

In some embodiments, the dough composition can include potato flakes, potato flour, and a starch. In some embodiments, the starch can be a potato starch or a corn starch.

In some embodiments, the dough composition can include various components including, but not limited to, a corn flour, a tapioca flour, a starch, and the like. In some embodiments, the starch can specifically be corn starch.

Corn flour (or maize flour) is flour made from corn. Per 21 C.F.R. 137.211 white corn flour and 137.215 yellow corn flour is prepared by grinding and bolting cleaned yellow or white corn that when tested by the method prescribed in 21 C.F.R 137.211(b)(2) not less than 98 percent passes through a No. 50 sieve and not less than 50 percent passes through a No. 70 woven-wire cloth.

The corn flour used with embodiments herein can include components such as corn masa flour (or masa harina) and whole grain corn flour. Corn masa is a soft flour made from finely ground hominy or dried corn kernels that have been cooked and soaked in an alkaline solution such as a diluted solution of calcium hydroxide In some embodiments, the corn flour can include a mixture of corn masa flour and whole grain corn flour in a ratio of about 5/1, 6/1, 7/1, 8/1, 10/1, 12/1, 14/1, 16/1, 18/1 or 20/1 by weight or falling within a range between any of the foregoing. In various embodiments, the corn flour can include pre-gelatinized corn flour made from whole yellow corn. In some embodiments, blends of different flours can be used.

Tapioca flour is made from the crushed pulp of the Cassava root. Tapioca flour is typically a fine, white powder. In some embodiments, the tapioca flour used with embodiments herein can include partially gelatinized tapioca flour. Starch gelatinization is a process of breaking down the intermolecular bonds of starch molecules in the presence of water and heat, allowing the hydrogen bonding sites to engage or complex with more water molecules. In some embodiments, the tapioca flour used with embodiments herein can include instant or cold water soluble/swelling tapioca flour. The tapioca flour is present in an amount of about 5, 7.5, 10, 12.5, 15, 17.5, 20, 22.5, 25, 27.5, or 30 percent by weight relative to the weight of the corn flour component or an amount falling within a range between any of the foregoing. In some embodiments, the dough composition includes 10 to 20 percent by weight relative to the corn flour component.

Corn starch is a starch product made from corn. In various embodiments herein, the corn starch can include partially gelatinized starch. As referenced above, starch gelatinization is a process of breaking down the intermolecular bonds of starch molecules in the presence of water and heat, allowing the hydrogen bonding sites to engage or complex with more water molecules. In some embodiments, the tapioca flour used with embodiments herein can include instant or cold water soluble/swelling corn starch. In various embodiments, the corn starch is present in an amount of about 2.5, 5, 7.5, 10, 12.5, 15, 17.5, 20, 22.5 or 25 percent by weight relative to the corn flour component or an amount falling within a range between any of the foregoing. In some embodiments, the dough composition includes corn starch in an amount of 5 to 15 percent by weight relative to the corn flour component. In some embodiments, blends of different starches can be used.

The dough composition can include a substantial moisture content prior to baking. In some embodiments, the dough composition prior to baking can include from about 25 to 40 weight percent water.

The dough composition can include an oil component. In some embodiments, the dough composition can include about 3 to 10 weight percent oil. In some embodiments, the oil can include a vegetable oil. Various types of vegetable oils can be used including, but not limited to, corn oil, sunflower seed oil, safflower oil, canola/rapeseed oil, soybean oil, cottonseed oil, palm oil, palm kernel oil, coconut oil, olive oil, grapeseed oil, hemp oil, peanut oil, and the like, or a combination thereof.

The total content of oil in the baked snack can be higher than in the dough composition based on oil added with seasonings or flavor compositions and in various processing steps. In some embodiments, the baked snack can include less than 25, 20, 17, 15, 14, 13, 12, 11, 10, 8 or 5 percent by weight oil content. In various embodiments herein, the baked snacks can include a total content of oil that is substantially less than comparable fried snacks.

In some embodiments, the dough composition can include a leavening agent. Exemplary leavening agents can include, but are not limited to, biological and chemical leavening agents. Chemical leavening agents typically produce carbon dioxide and water vapor. Chemical leavening agents can include fast-acting, slow-acting, and double-acting chemical leavenings. In some embodiments, leavening agents can specifically include a base (such as ammonium bicarbonate, potassium bicarbonate, or sodium bicarbonate) plus one or more acids or acid salts. Exemplary acids/acid salts can include, but are not limited to potassium acid tartrate (cream of tartar), monocalcium phosphate (MCP), sodium acid pyrophosphate (SAPP), sodium aluminum phosphate (SALP), dicalcium phosphate dihydrate, sodium aluminum sulfate, glucono delta-lactone (GDL), fumaric acid, and the like. In some embodiments, chemical leavening agents herein can include sodium bicarbonate and monocalcium phosphate monohydrate. In some embodiments, chemical leavening agents can include sodium bicarbonate and sodium pyrophosphate. In some embodiments, chemical leavening agents can include sodium aluminum sulfate and monocalcium phosphate.

Various other components can also be included in doughs herein including, but not limited to, fortifying vitamins and minerals, cheese, yeast, salts, milk, yeast, spices, natural and artificial flavorings, antioxidants, microbial growth inhibitors, visual appearance enhancers such as toasted corn germ, and the like.

### Methods

Embodiments herein can include methods of making a baked snack. In an embodiment, a method of making a baked snack includes forming a dough composition. The dough composition can include a corn flour, 10 to 20 percent of a tapioca flour relative to the weight of the corn flour, 5 to 15 percent of a corn starch relative to the weight of the corn flour, 25 to 40 weight percent water, 3 to 10 weight percent vegetable oil, and a leavening agent. In various embodiments, the method can include sheeting the dough. Dough can be sheeted at various thicknesses. By way of example, dough can be sheeted at a thickness of about 1, 1.5, 1.8, 2, 2.1, 2.2, 2.3, 2.4, 2.5, 2.6, 3, 3.5, 4, 4.5, 5 or 6 millimeters or an amount falling within a range between any of the foregoing. In some embodiments, the dough can specifically be sheeted to a thickness of 1.5 to 3 millimeters.

In various embodiments, the method can include cutting the sheeted dough to form individual pieces. The individual pieces can have various dimensions and shapes, such as those described elsewhere herein.

In various embodiments, the method can include baking the individual pieces to reduce the moisture content to less than about 6, 5, 4, 3.5, 3 or 2.5 weight percent. In some embodiments, the moisture content can specifically be reduced to 3.5 percent or less.

Aspects may be better understood with reference to the following examples. These examples are intended to be representative of specific embodiments, but are not intended as limiting the overall scope of embodiments herein.

### EXAMPLES

### Example 1: Formation of Baked Snack

A dough composition batches were prepared by mixing components as shown below in TABLE 1 in a batch mixer.

TABLE 1

| DOUGH COMPONENT | AMOUNT |
|---|---|
| Corn Flour (masa flour and pre- | Base component for dough, other |
| gelatinized corn flour | components measured relative to the |
| made from whole yellow corn) | corn flour component. |
| Tapioca Flour (cold water | 10% to 20% based on weight of corn |
| swelling) | flour component |
| Instant Corn Starch (cold | 5% to 15% by weight based on the |
| water soluble/swelling and pre- | weight of the corn flour component |
| gelatinized) | |
| Water | an amount sufficient to make the total |
| | moisture content of dough equal to 25% |
| | to 40% by weight of dough |
| Vegetable Oil | 3% to 10% by weight based on the |
| | weight of the dough |
| Leavening (monocalcium | 1% to 2% by weight based on the |
| phosphate and sodium | weight of the corn flour component |
| bicarbonate) | |

The dough composition was sheeted to a thickness of 1.5 to 3 mm and then cut into a shape using a cutter roll and a web is pulled to get a shape approximately as shown in FIG. 1 to form individual snacks. The snacks were then baked at approximately 450 degrees Fahrenheit for an amount of time sufficient to reduce the moisture content of the snacks to less than about 3.5% by weight. A flavoring composition comprising oil and flavorings was then applied to the individual snacks.

### Example 2: Evaluation of Physical Configuration

A hollow cavity which differs in height across the body/shape is key to providing a texture experience with varying levels of crunchiness with each bite. This provides a textural differentiation from tortilla chips which are characterized by the presence of blisters/bubbles.

Texture and three-dimensional scanning show how the product differs across the different sections of the product which supports the hypothesis.

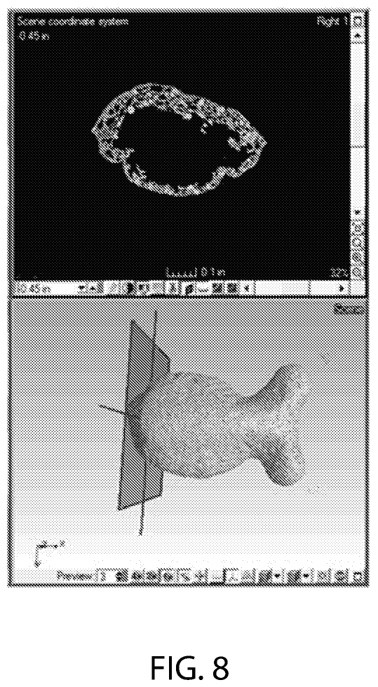

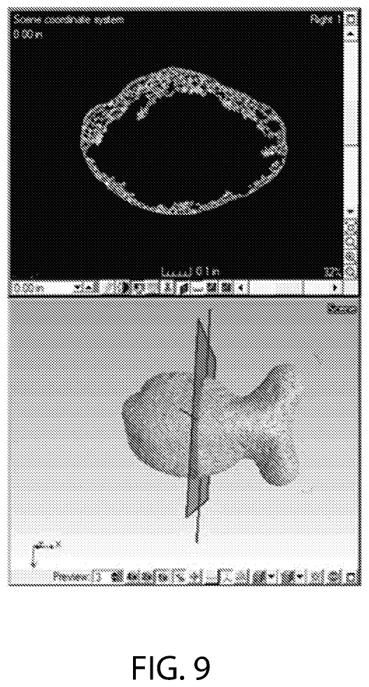

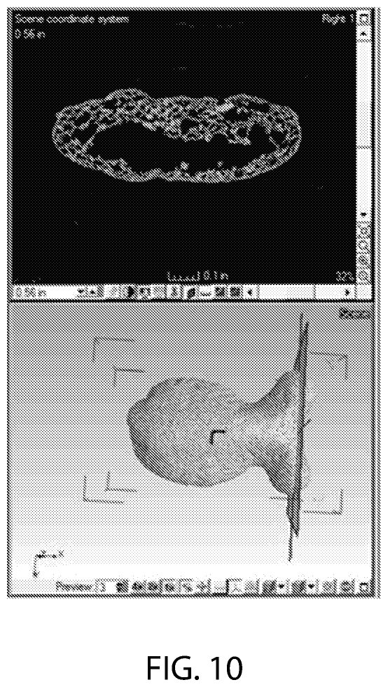

Three-dimensional scanning images show that the distance between the top and bottom layer changes as you move from the tip to the tail. FIG. 8 is a three-dimensional scan and cross-section of a tip portion of a baked snack in accordance with various embodiments herein. FIG. 9 is a three-dimensional scan and cross-section of a middle portion of a baked snack in accordance with various embodiments herein. FIG. 10 is a three-dimensional scan and cross-section of a tail section of a baked snack in accordance with various embodiments herein.

The difference in distance impact crispness/crunch and the force to compress the product. Images also show that wall thickness across the product variates from top to bottom and from tip to tail with thicker cell walls closer to the tip and tail sections which likely impact the force required to compress the product.

The three-dimensional product structure, in combination with recipe and product design/shape yield a multi-dimensional texture experience (not monotonous) which is different from other snacks products in market.

### Example 3: Mechanical Compression Analysis

Four products were tested for mechanical, acoustic and descriptive sensory analyses. These included nacho cheese flavor BUGLES® brand corn chips (“Comparative Example 1”—commercially available from General Mills, Inc.), white cheddar flavor POPPABLES® brand potato snacks (“Comparative Example 2”—commercially available from Frito-Lay, Inc.), and original flavor Pretzel SHELLS® brand pretzel snacks (“Comparative Example 3”—commercially available from Unique Pretzel Bakery, Inc.). These three comparative examples were compared with a baked snack created as described in Example 1 herein.

The mechanical texture was evaluated under a single compression test, which is typical of snack items as they exhibit multiple fractures under compression, which is part of what produces the sensation of crispness or crunchiness. In specific, individual snack items were placed on the base platform of a Stable Microsystems TX.AT Plus texture analyzer. A 2″ disc compressed the samples at a rate of 2 mm/second and to a distance of 8 mm. This single compression test was repeated approximately 30 times for each snack type tested.

The analyses specifically included:

Initial Gradient:

measures the initial build-up of force before the item first fractures. This is most related to the elastic modulus of the solid material, thus is one measure of overall hardness experienced on the initial bite.

Number of Fracture Peaks:

As noted, crisp foods break at multiple levels during continued compression. The number of fracture events varies with the item and can be an indicator of how the snack comes apart and would be a qualitative indicator of the crispness sensation.

Linear Distance:

In general, crisp and crunchy items have very jagged response curves. In comparison, ductile or elastic items would have a very smooth response of force with distance. On way of measuring the noisy response is through the “linear distance” algorithm. This measures the total length travelling point to point through the data. Thus, higher numbers correspond to more noisy or jagged response curves.

Average Drop-Off:

After a fracture a large part of the structure may remain intact, or major parts may give way. A large drop-off force indicates that much of the structure is separated after fracture.

Values obtained were as shown in Table 2 below.

TABLE 2

| | | Initial | Number | Linear | Average | Final |
|---|---|---|---|---|---|---|
| | | Gradient | of | Distance | Dropoff | Force |
| | | (g/s) | Peaks | (g s) | (g) | (g) |
| Baked | Mean | 2195 | 72 | 81902 | 527 | 9952 |
| Snack | St. Dev. | 2420 | 8 | 21804 | 142 | 4655 |
| Herein | | | | | | |
| Comp. | Mean | 1785 | 70 | 19470 | 112 | 2542 |
| Ex. 1 | St. Dev. | 1092 | 14 | 12791 | 53 | 3681 |
| Comp. | Mean | 1989 | 60 | 12581 | 95 | 363 |
| Ex. 2 | St. Dev. | 1027 | 13 | 3950 | 21 | 365 |
| Comp. | Mean | 6332 | 51 | 16690 | 164 | 6 |
| Ex. 3 | St. Dev. | 3325 | 10 | 4182 | 47 | 5 |

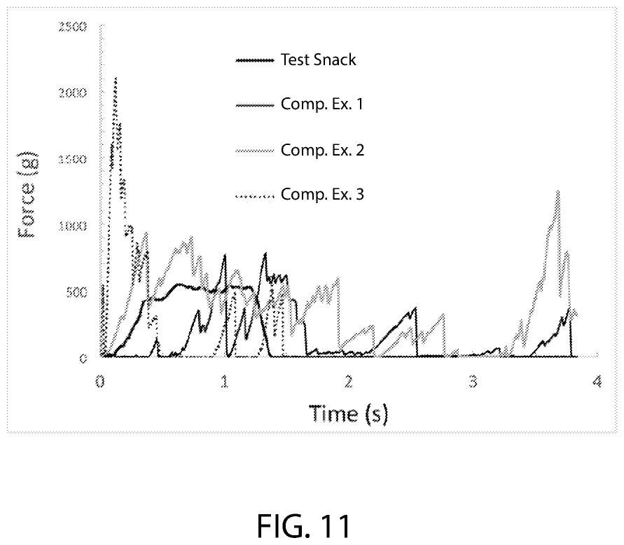

A force deformation plot for the baked snack herein along with the three comparative examples is shown in FIG. 11.

The baked snack herein had the greatest values for linear distance and average drop-off (Table 2). The linear distance is taken as a measure of crispness/crunchiness intensity which in this case indicates the baked snack herein is fundamentally different from the other snacks and is crispier/crunchier. This also corresponded to the drop-off forces with baked snack herein having the greatest value. Larger drop-off events are more associated with crunchiness.

### Example 4: Acoustical Analysis

Sounds were also measured while the snack items were being tested as described in Example 3 above. The sounds were recorded using an Audix testing microphone positioned 2 cm from the compression probe. Sounds were collected during the compression, then trimmed to include the 4 s after the probe contacted the sample surface. The sound files were analyzed using MatLab. The analyses included period and included total sound intensity, number of peaks (above threshold), and analyses of frequency components. The analysis specifically included:

Overall Sound Intensity:

The overall sound intensity was determined by integrating the sound data over the 4 s collection period. In general, louder sounds would be associated with greater crispness/crunchiness levels.

Number of Peaks:

As with mechanical fracture peaks, the sound peaks correspond with individual breakages any many peaks would be expected in order to create a crispness sensation during compression. It should be noted that the peaks are determined as local maximum occurring above some threshold value.

Periodograms:

Crispness and crunchiness are also characterized by the relative collection of frequencies they contain. This can be determined by Fast Fourier Transformation of the time domain data and displaying a spectrogram of how the frequency contents vary with time. Alternately, the total data over time can be analyzed. While the FFT displays the weighted sums of frequencies, the power spectral density plot displays this as the relative weighted energy of each frequency.

The baked snack herein generated the greatest overall sound intensity (Table 3). In general, the loudness of sounds produced by biting are highly correlated with sensations of crispness. This suggests that the baked snack herein would produce the greatest crispness or crunchiness.

It is of interest that the average sound intensity was most correlated with the mechanical measures of final force (R2=0.96), average drop-off force (R2=0.91) and linear distance (R2=0.85). It has been established that consumers can use both mechanical force changes in the mouth and sound as redundant pieces of information for evaluating crispness and crunchiness.

TABLE 3

| | | Avg. Intensity | No. |
|---|---|---|---|
| | | (AU) | Peaks |
| Baked Snack | Mean | 1937 | 153 |
| Herein | St. Dev. | 369 | 24 |
| Comp. Ex. 1 | Mean | 1599 | 76.5 |
| | St. Dev. | 100 | 39.5 |
| Comp. Ex. 2 | Mean | 1607 | 82.9 |
| | St. Dev. | 93.8 | 22.2 |
| Comp. Ex. 3 | Mean | 1449 | 80.2 |
| | St. Dev. | 426 | 23.6 |

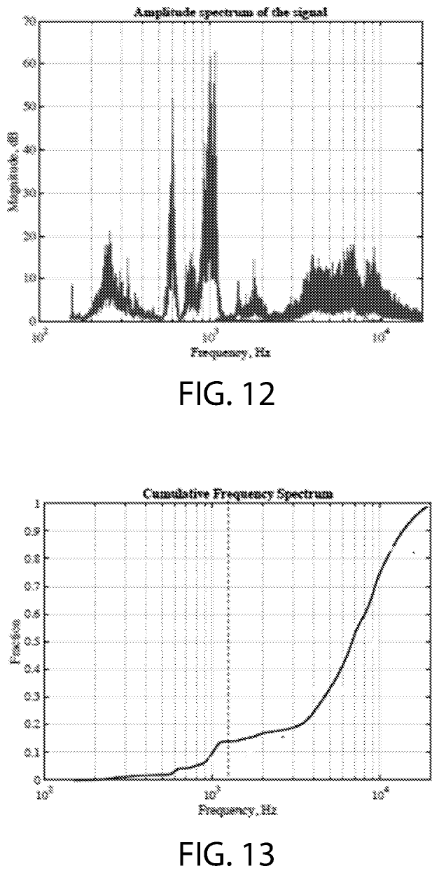

It has been suggested that the sensations of crispness or crunchiness might be related to the frequency (pitch) components contained in the audio signal. However, this does vary with the type of food tested. Typically, a frequency in the region of 1.6-1.9 kHz has been used as a marker. That is, crunchy foods often have more of their frequency content below the cut-off, crispier foods have more frequencies above the cut-off. FIGS. 12, 14, 16, and 18 show averaged power spectrum plots for each of the snacks tested. This shows an x-axis (on a log scale) consisting of the frequency spectrum (here between 100 and 20,000 Hz). The y-axis shows the relative weights of each of those frequencies. In general, crisp/crunchy items will have many frequency components and that is why they sound “noisy”. In addition, the spectra were reanalyzed to determine a cumulative frequency plot. FIGS. 13, 15, 17 and 19 illustrate for any given frequency what fraction of the signal lies below that frequency. Thus, frequency spectrum plots and cumulative frequency plots for the four snack types tested are shown in FIGS. 12-19 as summarized in Table 4 below.

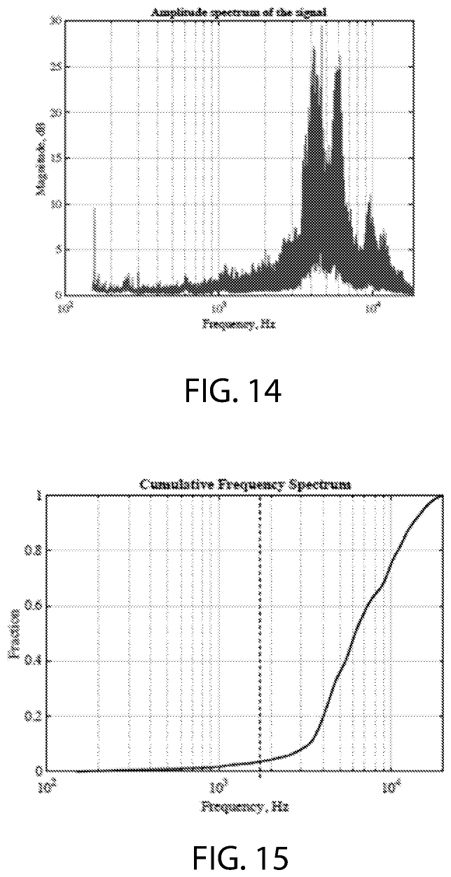

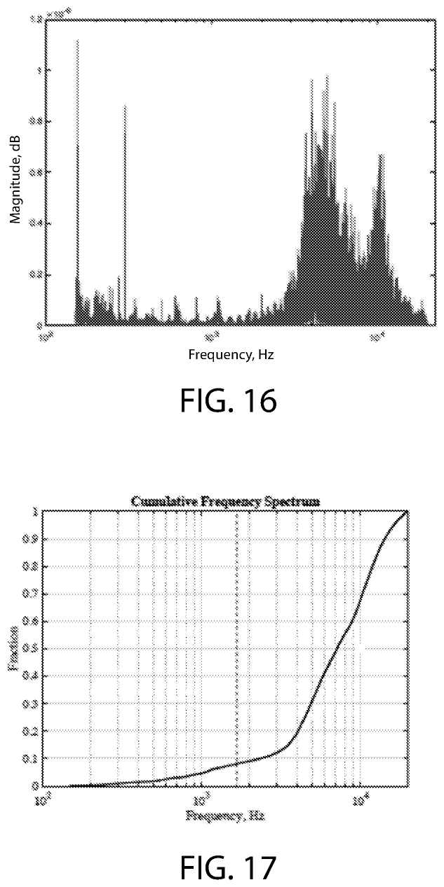

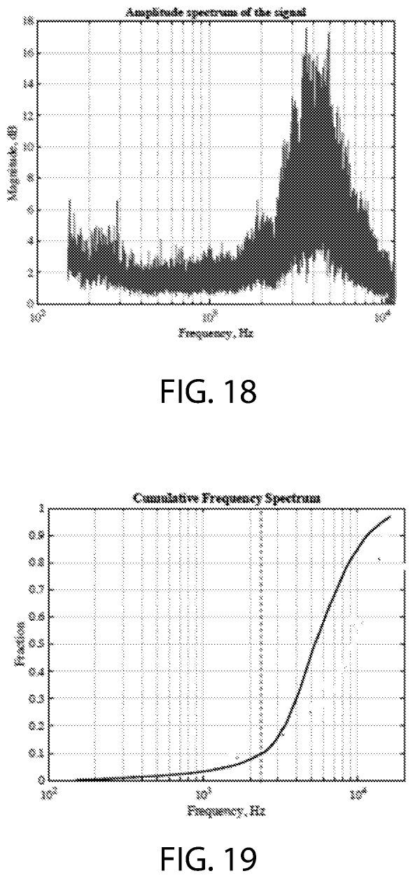

TABLE 4

| | | Cumulative |
|---|---|---|
| | Frequency | Frequency |
| Snack Type | Spectrum Plot | Spectrum Plot |
| Baked Snack Herein | FIG. 12 | FIG. 13 |
| Comparative Example 1 | FIG. 14 | FIG. 15 |
| Comparative Example 2 | FIG. 16 | FIG. 17 |
| Comparative Example 3 | FIG. 18 | FIG. 19 |

In general, comparative examples 1-3 contained more high-end frequencies with a few broad peaks over the 1000-20,000 Hz range. The cumulative plots showed only a small amount of frequencies below 1.7 kHz for comparative example 1 (3.52%), comparative example 2 (8.20%) and comparative example 3 (6.07%). That would suggest that these lie more towards the “crispy” spectrum.

The baked snack herein had more complicated frequency spectra with many large peaks over the ˜100-2000 Hz range, and a small spread of peaks over the 2500-20,000 Hz range. The cumulative plots showed that for the baked snack herein 15.38% of the components resided below 1.7 kHz.

### Example 5: Sensory Analysis

The differences in texture between the four tested snack types were also assessed by a trained sensory panel.

The texture profile was assessed throughout the chewing experience at the following points:

1. 1st bite (incisors—wide piece and narrow piece)

2. 1st bite (molars—whole piece)

3. Ongoing chewing

4. After swallowing

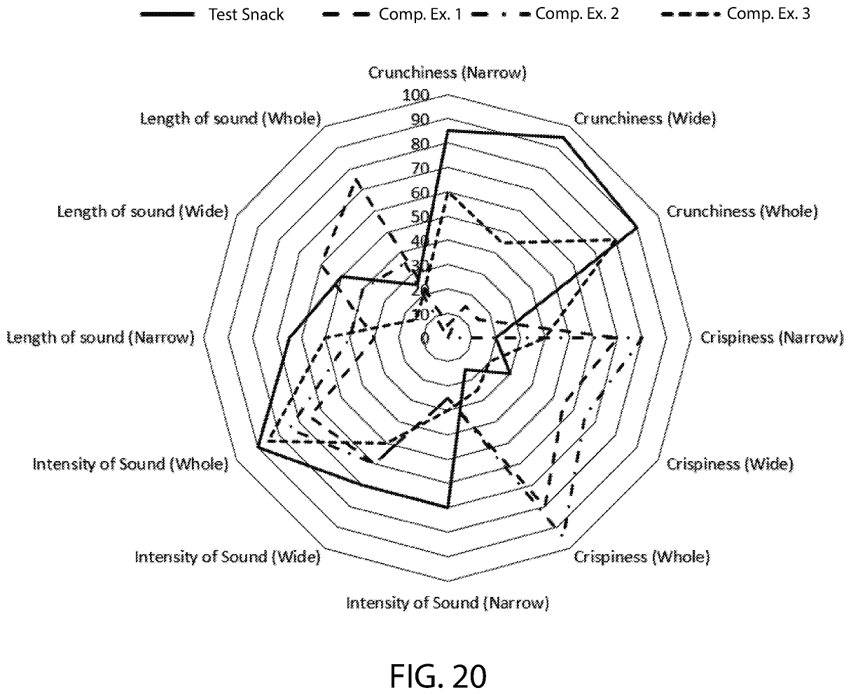

Results were collected using roundtable consensus scores, comparing all samples across attributes. Overall the baked snack herein was found to have a unique texture profile, compared to the other snacks tested. It stands out as noticeably louder, crunchier, harder and denser. The results are shown in FIG. 20 as a spider plot.

On first bite, the baked snack herein is most similar to the comparative example 3, being higher in crunchiness, length of sound & intensity of sound.

During ongoing chewing & after swallowing, the baked snack herein become closer to comparative example 1. Both products are more cohesive, grainy and toothpacking.

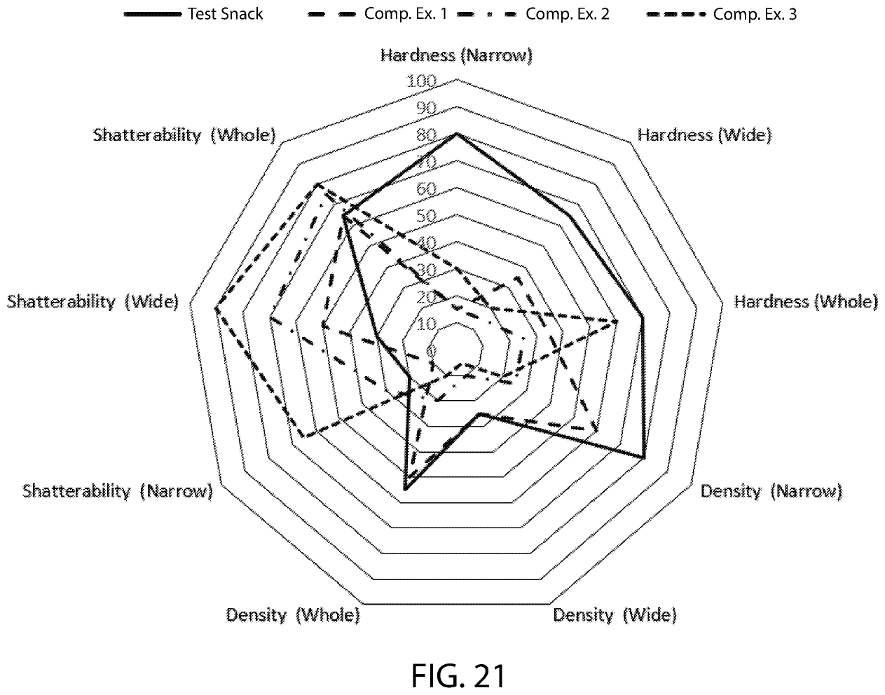

Comparative example 2 was most different from the baked snack herein throughout all stages of assessment. Comparative example 2 was crispy, had high shatterability and low hardness on first bite. During ongoing chewing & after swallowing, comparative example 2 dissolved, leaving a greasy/oily residue. The results are shown in FIG. 21 as a spider plot.

In general, the attributes associated with the first bite had more correlations with the instrumental measurements than those associated with ongoing chewing or after swallowing. This would be expected as the instrumental tests were based on single compressions by a probe, not repeated compressions meant to simulate chewing.

A few of the most noticeable correlations (p<0.05) are noted below:

Hardness:

Hardness on the first bite (incisor-narrow) is best correlated with drop-off force, linear distance and the number of sound peaks.

Crunchiness:

Crunchiness evaluated by the incisor (narrow section) was correlated with the measured sound intensity.

Sound Intensity:

The sound intensity evaluated by descriptive panelists (1st bite, narrow, incisors) was correlated with the drop-off force, number of sound peaks and linear distance. At p<0.1 it was also correlated with the maximum force and sound intensity.

Density:

Density on the first bite (incisor-narrow) is best correlated with the maximum force and total number of fracture peaks.

### Example 6: Comparative Evaluation of Physical Configuration

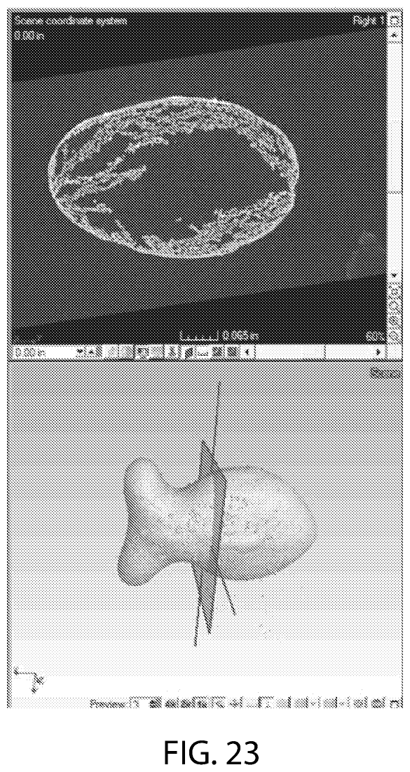

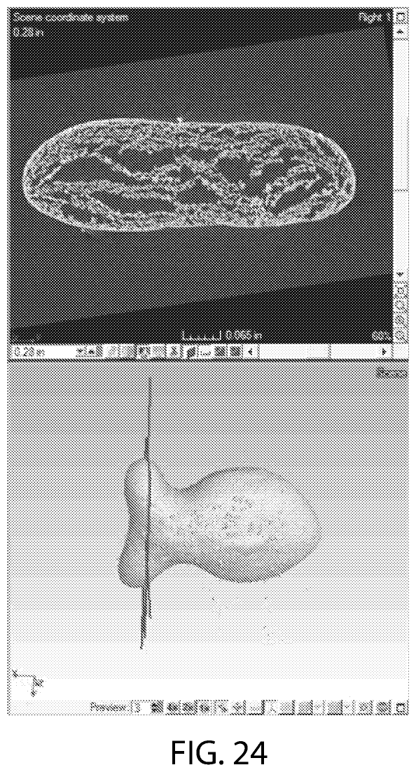

The three-dimensional structure of preexisting GOLDFISH® brand baked snacks with wheat-based formulations (“comparative cracker”) were evaluated in order to compare them with baked snacks herein as shown in FIGS. 8-10 and evaluated in Example 2 above. FIG. 22 is a three-dimensional scan and cross-section of a tip portion of the comparative cracker. It can be seen that the hollow cavity is almost non-existent. FIG. 23 is a three-dimensional scan and cross-section of a middle portion of the comparative cracker. It can be seen that the hollow cavity is much smaller as a proportion of the overall cross-section size in comparison to that shown in FIG. 9. FIG. 24 is a three-dimensional scan and cross-section of a tail section of the comparative cracker. It can be seen that there is no specific hollow cavity of any significant size. These three-dimensional scanning images show that the comparative crackers have a far-different cross-sectional structure than the baked snacks herein.

The difference in distance impact crispness/crunch and the force to compress the product. Images also show that wall thickness across the product variates from top to bottom and from tip to tail with thicker cell walls closer to the tip and tail sections which likely impact the force required to compress the product.

The three-dimensional product structure, in combination with recipe and product design/shape yield a multi-dimensional texture experience (not monotonous) which is different from other snacks products in market.

It should be noted that, as used in this specification and the appended claims, the singular forms “a,” “an,” and “the” include plural referents unless the content clearly dictates otherwise. Thus, for example, reference to a composition containing “a compound” includes a mixture of two or more compounds. It should also be noted that the term “or” is generally employed in its sense including “and/or” unless the content clearly dictates otherwise.

It should also be noted that, as used in this specification and the appended claims, the phrase “configured” describes a system, apparatus, or other structure that is constructed or configured to perform a particular task or adopt a particular configuration. The phrase “configured” can be used interchangeably with other similar phrases such as arranged and configured, constructed and arranged, constructed, manufactured and arranged, and the like.

All publications and patent applications in this specification are indicative of the level of ordinary skill in the art to which this invention pertains. All publications and patent applications are herein incorporated by reference to the same extent as if each individual publication or patent application was specifically and individually indicated by reference.

The embodiments described herein are not intended to be exhaustive or to limit the invention to the precise forms disclosed in the following detailed description. Rather, the embodiments are chosen and described so that others skilled in the art can appreciate and understand the principles and practices. As such, aspects have been described with reference to various specific and preferred embodiments and techniques. However, it should be understood that many variations and modifications may be made while remaining within the spirit and scope herein.

1. A baked snack comprising:
a three-dimensional structure comprising a top layer and a bottom layer and defining a hollow cavity between the top layer and the bottom layer, the three-dimensional structure formed from a dough composition comprising
a corn flour;
a tapioca flour; and
a starch;
the three-dimensional structure comprising a first end segment, a second end segment, and a middle segment disposed between the first end segment and the second end segment;
wherein an average height of the hollow cavity is less in the second end segment than in the first end segment; and
wherein an average height of the hollow cavity is less in the first end segment than in the middle segment.

2. The baked snack of claim 1,
wherein a combined average thickness of the top layer and bottom layer is greater in the second end segment than in the first end segment; and
wherein a combined average thickness of the top layer and bottom layer is greater in the first end segment than in the middle segment.

3. The baked snack of claim 1,
wherein the second end segment has an average cross-sectional ratio of a diameter of the hollow cavity to an outer diameter of the three-dimensional structure that is less than the first end segment; and
wherein the first end segment has an average cross-sectional ratio of a diameter of the hollow cavity to an outer diameter of the three-dimensional structure that is less than the middle segment.

4. The baked snack of claim 1, the middle segment comprising
the top layer defining a first arch;
the bottom layer defining a second arch, wherein the first arch and the second arch are inverted with respect to one another;
wherein the bottom layer defining the second arch has an average thickness that is greater than the top layer defining the first arch.

5. The baked snack of claim 4, wherein the bottom layer defining the second arch has an average thickness that is at least 10 percent greater than the top layer defining the first arch.

6. The baked snack of claim 4, wherein a force required to compress the second arch is at least 20 percent greater than a force required to collapse the first arch.

7. The baked snack of claim 1, wherein
the first end segment has a cross-sectional ratio of a diameter of the hollow cavity to an outer diameter of the three-dimensional structure of about 0 to 0.8;
the second end segment has a cross-sectional ratio of the diameter of a hollow cavity to an outer diameter of the three-dimensional structure of about 0 to 0.7; and
the middle segment has a cross-sectional ratio of the diameter of a hollow cavity to an outer diameter of the three-dimensional structure of about 0.6 to 0.95.

8. The baked snack of claim 1, the corn flour comprising a mixture of corn masa flour and whole grain corn flour in a ratio of 5/1 to 20/1 by weight.

9. The baked snack of claim 1, the tapioca flour comprising partially gelatinized tapioca flour.

10. The baked snack of claim 1, wherein the tapioca flour is present in an amount of 5 to 30 percent by weight relative to the corn flour component.

11. The baked snack of claim 1, the starch comprising partially gelatinized corn starch.

12. The baked snack of claim 11, wherein the corn starch is present in an amount of 5 to 20 percent by weight relative to the corn flour component.

13. The baked snack of claim 1, comprising less than 15 percent by weight oil content.

14. The baked snack of claim 1, wherein compression of the hollow cavity results in sound waves with a largest peak at a frequency of from 500 to 2000 Hertz.

15. The baked snack of claim 1, exhibiting a linear distance of from 60,000 to 110,000 g/s.

16. The baked snack of claim 1, exhibiting an average dropoff of from 300 to 700 g.

17. The baked snack of claim 1, exhibiting an average number of compression peaks of from 65 to 85.

18. A baked snack comprising:
a three-dimensional structure defining a hollow cavity;
the three-dimensional structure comprising a top layer and a bottom layer disposed opposite the top layer;
the top layer defining a first arch;
the bottom layer defining a second arch, wherein the first arch and the second arch are inverted with respect to one another;
wherein the bottom layer defining the second arch has an average thickness that is greater than the top layer defining the first arch.

19. The baked snack of claim 18, wherein the three-dimensional structure is formed from a dough composition comprising
a corn flour;
5 to 30 percent of a tapioca flour relative to a weight of the corn flour;
5 to 20 percent of a starch relative to the weight of the corn flour;
25 to 40 weight percent water;
3 to 10 weight percent vegetable oil; and
a leavening agent.

20. A baked snack comprising:
a three-dimensional structure comprising a top layer and a bottom layer and defining a hollow cavity between the top layer and the bottom layer, the three-dimensional structure formed from a dough composition comprising
potato flakes;
potato flour; and
a starch;
the three-dimensional structure comprising a first end segment, a second end segment, and a middle segment disposed between the first end segment and the second end segment;
wherein an average height of the hollow cavity is less in the second end segment than in the first end segment; and
wherein an average height of the hollow cavity is less in the first end segment than in the middle segment.
